(19) United States
(12) Patent Application Publication
(10) Pub. No.: US 2026/0220720 A1
(43) Pub. Date: Jul. 30, 2026

(54) BLOCKCHAIN-BASED WATER TRANSACTION METHOD AND SYSTEM, ELECTRONIC DEVICE AND STORAGE MEDIUM

(71) Applicant: THE 6TH RESEARCH INSTITUTE OF CHINA ELECTRONICS CORPORATION, Beijing (CN)

(72) Inventors: Dasong Zhang, Beijing (CN); Yuntao Yu, Beijing (CN); Chaobin Huo, Beijing (CN); Hongzhao Jiang, Beijing (CN)

(21) Appl. No.: 19/143,411

(22) PCT Filed: Dec. 20, 2023
(86) PCT No.: PCT/CN2023/140360

§ 371 Date: Nov. 10, 2025

(30) Foreign Application Priority Data
Dec. 27, 2022 (CN) 202211714488.5

(51) Int. Cl. G06Q 50/06; G06Q 20/36; G06Q 20/38

(52) U.S. Cl. CPC G06Q 50/06; G06Q 20/36; G06Q 20/389

(57) ABSTRACT

Provided are a blockchain-based water service transaction method, a blockchain-based water service transaction system, an electronic device, and a storage medium. the blockchain-based water service transaction system comprises: a user unit, wherein the user unit comprises a user wallet module and a user transaction module, the user transaction module is configured to generate water service transaction information based on a water service transaction behavior of a user and the user wallet module, the user wallet module is configured to manage wallet information of the user, and the user wallet module is a wallet module constructed by the blockchain; a contract unit configured to establish a water scheduling contract based on the water service transaction information; and a scheduling unit communicatively connected to a water service system and configured to control the water service system to supply water to the user based on the water scheduling contract.

### CROSS-REFERENCE TO RELATED APPLICATION

The present disclosure claims priority to Chinese patent Application No. 202211714488.5, filed with the Chinese Patent Office on Dec. 27, 2022, entitled “BLOCKCHAIN-BASED WATER TRANSACTION METHOD AND SYSTEM, ELECTRONIC DEVICE AND STORAGE MEDIUM” the entire contents of which are incorporated herein by reference.

### TECHNICAL FIELD

The present disclosure relates to the field of water service transactions, and specifically to a blockchain-based water service transaction method, a blockchain-based water service transaction system, an electronic device, and a storage medium.

### BACKGROUND ART

A water service system is used to supply water to a user, and a water service transaction system is connected to the water service system. The water service transaction system is used to send recorded information related to the transaction to the water service system according to the transaction behavior of the user regarding the water service, so that the water service system supplies water to the user. For example, after a user makes a recharge on the water service transaction system, the water service transaction system can control the water service system to supply water to the user based on the recharge record of the user.

However, the current water service transaction system is a relatively common e-commerce transaction system, with a lower security of the water service transaction. It is easy to appear the leakage of user information, theft of water resources, tampering with water usage data, and other possible security problems during the process of water service transactions, which can lead to the theft and waste of water resources, etc.

### SUMMARY

In view of this, the present disclosure provides a blockchain-based water service transaction method, a blockchain-based water service transaction system, an electronic device, and a storage medium, which improve the security and accuracy of the water service transaction process.

Some embodiments of the present disclosure provide a blockchain-based water service transaction system, and the blockchain-based water service transaction system can include: a user unit, wherein the user unit includes a user wallet module and a user transaction module; the user transaction module is configured to generate water service transaction information based on a water service transaction behavior of a user and the user wallet module; the user wallet module is configured to manage wallet information of the user; and the user wallet module is a wallet module constructed by the blockchain; a contract unit, wherein the contract unit is configured to establish a water scheduling contract based on the water service transaction information; a scheduling unit, wherein the scheduling unit is communicatively connected to a water service system, and the scheduling unit is configured to control the water service system to supply water to the user based on the water scheduling contract.

In the embodiment of the present disclosure, the user wallet module is a wallet module constructed by blockchain, and the blockchain technology has a higher level of security, which can improve the security of the user wallet information and protect the financial security of the user. Meanwhile, when conducting the transaction by using a blockchain wallet, the blockchain technology can record and save the transaction process, thereby improving the security of the transaction. After generating the water service transaction information, it establishes the water scheduling contract and directly controls the water service system to supply water based the water scheduling contract, which can avoid tampering of water supply transaction information, and avoid the condition that the water service system does not supply water according to the actual transaction, so as to further improve the security of the transaction.

In some embodiments of the present disclosure, the user wallet module can be constructed based on the blockchain, and the user wallet module can manage the wallet information of the user based on an incentive mechanism of the blockchain.

In the embodiment of the present disclosure, the wallet information of the user is managed by using the blockchain-based incentive mechanism, and the blockchain incentive mechanism has good real-time performance. After the transaction is completed, the token transfer can be completed quickly, so as to solve the problem such as data tampering during the transaction process, which may affect the security of the transaction.

In some embodiments of the present disclosure, the user unit can further include a user information module, and the user information module is configured to record multiple types of information of the user.

In some embodiments of the present disclosure, the user unit can further include a user management module, and the user management module is configured to manage own affairs of the user.

In some embodiments of the present disclosure, the contract unit can include a blockchain module and a contract module, wherein the blockchain module is configured to enable the contract unit to perform basic functions of the blockchain, and the contract module is configured to generate a smart contract corresponding to the water scheduling contract based on the water service transaction information and the functions of the blockchain module.

In some embodiments of the present disclosure, the scheduling unit can include: a contract review module, wherein the contract review module is configured to review a validity of the water scheduling contract based on the water service transaction information and to refuse to execute a water scheduling contract whose validity does not satisfy a preset requirement.

In the embodiment of the present disclosure, by setting the contract review module to review the validity of the water scheduling contract and to refuse to perform the water scheduling contract whose validity does not satisfy the preset requirement, it can avoid the condition that the water service system does not accurately supply water when either the water scheduling contract or the transaction information is tampered with, so that the transaction can be accurately performed, and the security and reliability of the transaction can be improved.

In some embodiments of the present disclosure, the scheduling unit can include: a virtual water meter object buffer pool, wherein the virtual water meter object buffer pool includes a plurality of virtual water meter objects, and each of the virtual water meter objects is synchronized with information of different water meters in the water service system respectively; and a virtual valve control module, wherein the virtual valve control module is communicatively connected to a water supply valve of the water service system, and the virtual valve control module is configured to control opening and closing of the water supply valve based on the water scheduling contract and the virtual water meter, so that the water service system supplies water to the user.

In the embodiments of the present disclosure, the information of the virtual water meter object is synchronized with the water meter information of the water service system, and therefore, the actual water supply situation of the water service system can be acquired through the virtual valve. The virtual valve control module is communicatively connected to the water supply valve of the water service system, so that the virtual valve control module can control the water supply of the water service system. When the scheduling unit controls the water service system to perform the transaction of the water supply, it can acquire the water supply condition of the water service system in real time. Therefore, it can monitor the execution condition of the water scheduling contract, which avoids the data tampering, and improves the security and reliability of the transaction. Meanwhile, the virtual valve control module can directly control the water supply valve of the water service system, so that the water service system is strictly performed according to the water scheduling contract, which further improves the reliability of the transaction, and protects the rights and interests of the two parties in the transaction.

In some embodiments of the present disclosure, wherein the scheduling unit can further include a buffer queue module; the buffer queue module is configured to cache a plurality of water scheduling contracts, and to control the plurality of water scheduling contracts to enter the contract review module in sequence; and the scheduling center executes the reviewed smart contract in sequence.

In some embodiments of the present disclosure, the blockchain-based water service transaction system can further include: a simulation unit, and the simulation unit is configured to simulate a water supply capacity of the water service system. The simulation unit includes a virtual water meter and a virtual valve; the virtual water meter is configured to simulate a water meter entity of the water service system; the water meter entity is configured to display a water supply volume of the water service system; the virtual valve is configured to simulate the valve entity of the water service system; and the valve entity is configured to control the water supply of the water service system.

In the embodiments of the present disclosure, by using the simulation unit to simulate the water supply capacity of the water service system, it can effectively reduce the cost of acquiring the actual water supply capacity of the water service system. Meanwhile, by simulating the actual water supply capacity of the water service system, the transaction can be performed according to the actual water supply capacity of the water service system, so as to improve the reliability of the transaction. The virtual water meter and virtual valve can characterize the water supply capacity of the water service system to some extent, so that the simulation process of the entire water service system can be simplified by simulating the virtual water meter and the virtual valve, so as to improve the efficiency of acquiring the actual water supply capacity of the water service system.

Another embodiment of the present disclosure provide a blockchain-based water service transaction method, and the blockchain-based water service transaction method can include: generating water service transaction information based on a water service transaction behavior of a user and wallet information of the user, wherein the wallet is a blockchain wallet; establishing a water scheduling contract based on the water service transaction information; and controlling a water service system to supply water to the user based on the water scheduling contract.

In some embodiments of the present disclosure, before a step of generating water service transaction information based on a water service transaction behavior of a user and wallet information of the user, the blockchain-based water service transaction method can further include: constructing a wallet of the user based on the blockchain, so as to manage the wallet information of the user based on an incentive mechanism of the blockchain.

In some embodiments of the present disclosure, before a step of controlling a water service system to supply water to the user based on the water scheduling contract, the blockchain-based water service transaction method can further include: reviewing a validity of the water scheduling contract based on the water service transaction information, and refusing to execute a water scheduling contract whose validity does not satisfy a preset requirement.

Another embodiments of the present disclosure further provide an electronic device, and the electronic device includes a memory and a processor, wherein the memory stores a computer-readable instruction; and when the computer-readable instruction is performed by the processor, the processor executes the blockchain-based water service transaction method according to some embodiments of the present disclosure or implements functions of the blockchain-based water service transaction system according to another embodiments of the present disclosure.

Another embodiment of the present disclosure further provides a computer-readable storage medium, and the readable storage medium stores a computer program, wherein when the computer program is performed on a computer, the computer executes the blockchain-based water service transaction method according to some embodiments of the present disclosure or implements functions of the blockchain-based water service transaction system according to another embodiment of the present disclosure.

### BRIEF DESCRIPTION OF DRAWINGS

In order to more clearly illustrate the technical solutions in the embodiments of the present disclosure, the drawings to be used in the embodiments of the present disclosure will be briefly introduced below. It is to be understood that the following drawings only show certain embodiments of the present disclosure, and therefore should not be regarded as a limitation of the scope. For persons of ordinary skill in the field, other relevant drawings can be obtained according to these drawings without inventive efforts.

FIG. 1 shows a structure schematic diagram of a blockchain-based water service transaction system provided by an embodiment of the present disclosure;

FIG. 2 shows a flow diagram of a blockchain-based water service transaction method provided by an embodiment of the present disclosure;

FIG. 3 shows an interaction schematic diagram of a blockchain-based water service transaction system provided by an embodiment of the present disclosure; and

FIG. 4 shows a structure schematic diagram of an electronic device provided by an embodiment of the present disclosure.

Reference numbers: electronic device 300; processor 310; memory 320.

### DETAILED DESCRIPTION OF EMBODIMENTS

In order to make the objectives, technical solutions, and advantages of the present disclosure more clearly to be understood, the present disclosure is described in further detail below in conjunction with the drawings and the embodiments. It should be understood that the specific embodiments described herein are intended only to illustrate the present disclosure, and are not intended to limit the present disclosure.

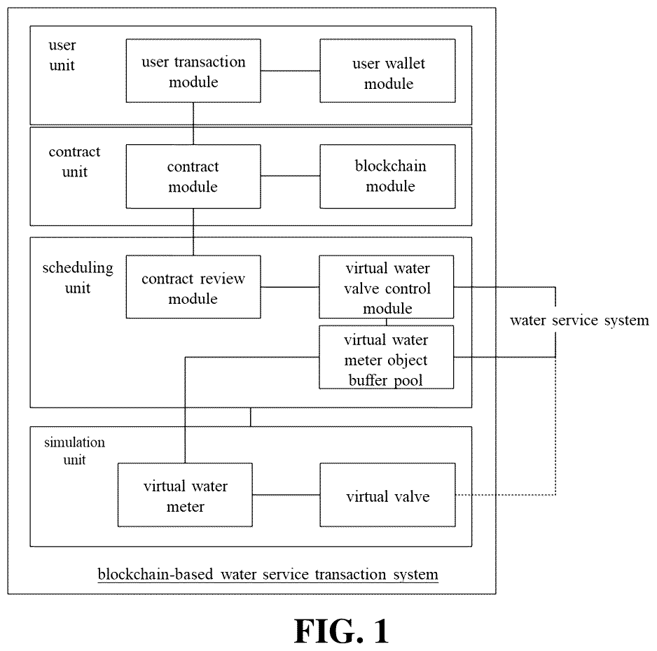

Referring to FIG. 1, FIG. 1 shows a structure schematic diagram of a blockchain-based water service transaction system provided by the embodiments of the present disclosure. The blockchain-based water service transaction system can include: a user unit, a contract unit, and a scheduling unit.

The user unit can be provided on the user side, so that the user can perform the water service transaction behavior.

In the embodiment, the user unit can be deployed at the visualization front end of the electronic device, for example, the user unit can be a cell phone or a computer program, and a web interface. The user unit can be implemented on an electronic device such as a computer or a cell phone, so that the user can perform the water service transaction behavior through the computer, cell phone, or other electronic devices.

In the embodiments of the present disclosure, the user unit can include at least a user wallet module and a user transaction module.

The user wallet module can be configured to allow the user to manage funds. For example, the user wallet module can be configured to record information of the transaction or fund-related activities of users such as recharge, settlement, and purchase.

The user wallet module can be a user wallet module constructed based on the blockchain.

The blockchain has the characteristic of decentralization, and it can store data in a decentralized manner across different nodes in the blockchain network. As a result, the data can be recorded by different nodes. Moreover, the blockchain has an encryption algorithm, which can avoid the data tampering. In addition, the blockchain further has a consensus mechanism, which can further reduce the possibility of data tampering.

In the embodiment, the user wallet module is constructed by blockchain technology, which can improve the security of the user wallet module, so as to ensure the validity of each transaction when the user performs the water service transaction by using the user wallet module. It can ensure that the user fund information is not tampered before the transaction, and after the transaction, the transaction behavior can be recorded in the blockchain, so that the transaction behavior is traceable. Therefore, the user wallet module constructed by the blockchain can improve the security of water service transactions.

In one embodiment, the user wallet module can manage the wallet information of the user based on an incentive mechanism of the blockchain.

In the embodiment, the user wallet module is constructed by the blockchain. Optionally, the user wallet module can be managed by using the incentive mechanism of the blockchain, wherein the token in the blockchain incentive mechanism can be used as the transactional token of the water service transaction. The user can use or obtain the token by actions such as transaction and recharge, so as to complete the water service transaction.

The blockchain incentive mechanism has good real-time performance. After the transaction is completed, the token transfer can be completed quickly, so as to solve the security problem such as the data tampering during the transaction process.

For the relevant content about blockchain mentioned in the above process, the specific principles can be referred to in the related arts, which will not be repeated herein.

The user transaction module can be configured to complete the water service transaction behavior of the user, and to generate the water service transaction information based on the water service transaction behavior of the user and the user wallet module.

In the embodiment, the user transaction module can provide the user with the transaction information, such as the water supplier and water price; and the user transaction module can perform functions in the water service transaction, such as the initiation, price comparison, locking, purchase, settlement, cancellation, and complaint, based on the water service transaction behavior of the user.

Exemplarily, the users can access the water service transaction information by the user transaction module, and select the purchase object and quantity based on their own needs. After the purchase behavior of the user is confirmed, the user transaction module will record the object, quantity, price, and other relevant information according to the transaction of the user. Meanwhile, the fund information of the user in the user wallet module will be confirmed and modified. When it is confirmed that the fund of the user is sufficient to pay for the purchased object, the fund of the user will be deducted, and the water service transaction information will be generated, so that purchase behavior of the user on the user unit is completed. The above is only an example, and the user transaction module can generate the water service transaction information based on other transaction behaviors of the user. The specific implementation process can refer to the relevant arts, which will not be repeated herein.

In some embodiments, the user unit can further include a user information module. The user information module can be configured to record various types of the user information, for example, the user information module can record the personal information, transaction records, and consumption records of the users, and the users can query information related to themselves through the user information module. In some embodiments, the user unit can further include a user management module, and the user management module is configured to manage own affairs of the user. Exemplarily, the user management module can set a purchase limit, and a consumption limit, etc.

The contract unit can be configured to establish a water scheduling contract based on the water service transaction information.

After the user completes the transaction behavior on the user unit, the user can obtain the water service transaction information. In the embodiment, a water scheduling contract, which is a contract for controlling water supply by the water supplier based on the water service transaction information, can be generated through a contract unit. In the water scheduling contract, the related water service information, such as water supply volume, can be stipulated, so that the water supplier performs the water supply according to the water scheduling contract.

In the embodiment, the contract unit can be deployed at the back end of the electronic device. For example, the contract unit can be applied at the back end of a server. The back end of the server is communicatively connected to the electronic device where the user unit is located, receives the water service transaction information generated by the user unit, and generates the water scheduling contract based on the water service transaction information.

In some embodiments, the water scheduling contract is a smart contract based on the blockchain. The contract unit can include a blockchain module and a contract module.

The blockchain module can be configured to enable the contract unit to perform basic functions of the blockchain, and the contract module can be configured to generate a smart contract corresponding to the water scheduling contract based on the water service transaction information and the functions of the blockchain module.

The smart contract of blockchain has the characteristics of non-tampering, traceability, and automatic execution. After establishing the smart contract of water service transaction, both transaction parties strictly perform the transaction according to the smart contract, which solves the problems affecting the security and reliability of the transaction, such as the data tampering and non-execution of the transaction, thereby improving the security of the water service transaction.

In some embodiments, the contract module can further include an information database. Through the information database, various transaction information, water scheduling contracts, transactions, and other information can be stored.

The scheduling unit is communicatively connected to the water service system, and the scheduling unit is configured to control the water service system to supply water to the user based on the water scheduling contract.

In the embodiment, the water service system is a system for supplying water to the user, e.g., a water supply system of a water plant. The scheduling unit is communicatively connected to water supply valves in the water service system, so that the scheduling unit can control the opening and closing of the water supply valves to supply water to the user. The user can be a household, a factory, or an area water-usage collective, etc. The water supply valve can be a water supply valve that includes, but is not limited to a household, a factory, or a regional water-usage collective.

In an embodiment, the scheduling unit can include: a virtual water meter object buffer pool, wherein the virtual water meter object buffer pool includes a plurality of virtual water meter objects, and each of the virtual water meter objects is synchronized with information of different water meters in the water service system respectively; and a virtual valve control module, wherein the virtual valve control module is communicatively connected to a water supply valve of the water service system, and the virtual valve control module is configured to control opening and closing of the water supply valve based on the water scheduling contract and the virtual water meter, so that the water service system supplies water to the user.

In the embodiment, the virtual water meter object buffer pool can be a buffer pool established in the memory of the electronic device. The virtual water meter object buffer pool includes the plurality of virtual water meter objects; each virtual water meter object is a virtual water meter preset in the buffer pool matching the attributes of a real water meter in the water service system; and all real water meters in the water service system are communicatively connected to the electronic device where the scheduling unit is located. Therefore, the information of different water meters can be synchronized to each virtual water meter object respectively, so as to monitor the actual transaction status of the water service system by the virtual water meter object.

The valve entity of the water service system is connected to the water meter, and the water meter can be configured to record the actual water volume output by the valve entity. In the embodiment, the virtual valve control module is communicatively connected to the valve entity, and the virtual valve control module can control the opening and closing of the valve entity, so that the scheduling center can directly control the water supply of the water service system.

Through the virtual water meter object buffer pool and the virtual valve control module, after the scheduling unit obtains the water scheduling contract, it can control the opening and closing of the valve entity corresponding to the user according to the related content about the water supply volume in the water scheduling contract and the information of the virtual water meter object corresponding the user, so as to supply water to the user or to stop supplying water to the user. Since the scheduling center directly performs the transaction according to the contract, it can effectively avoid the condition that the transaction information in the water service system is tampered during the transaction process. For example, it can reduce the occurrence of excessive water supply or insufficient water supply, so as to maintain the interests of both transaction parties, and to improve the security and reliability of the transaction.

In an embodiment, the scheduling unit can include a contract review module. The contract review module can be configured to review a validity of the water scheduling contract based on the water service transaction information and to refuse to execute a water scheduling contract whose validity does not satisfy a preset requirement.

In the embodiment, the preset requirement can refer to whether the information in the water scheduling contract is consistent with the water service transaction information. The contract review module can compare the contents in the water scheduling contract with the contents in the water service transaction information to determine whether the contents are consistent. If they are consistent, the water scheduling contract is determined to be valid, and the scheduling center can supply water based on the water scheduling contract. If they are not consistent, the water scheduling contract is determined to be invalid, and the scheduling unit can refuse to perform the water scheduling contract.

The above reviewing method of the validity of the water scheduling contract is only exemplary, and is not intended to be a limitation of the present disclosure. By reviewing the validity of the water scheduling contract, it can avoid the condition that either the water scheduling contract or the transaction information is tampered, so that the transaction can be accurately performed, and the security and reliability of the transaction can be improved.

In an embodiment, the scheduling unit can further include a buffer queue module. The buffer queue module is configured to cache a plurality of water scheduling contracts, and to control the plurality of water scheduling contracts to enter the contract review module in sequence; and the scheduling center executes the reviewed smart contract in sequence.

Different users or the same user may successively perform multiple transactions, thereby generating multiple water scheduling contracts. In the embodiment, the buffer queue module can be used to cache various water scheduling contracts, and then sequentially review and perform them. This avoids problems that may occur during disordered review and execution of water scheduling contracts, such as loss of some contracts, long delays in review or execution, or data tampering before execution, which are an excessive number of water scheduling contracts. Therefore, the occurrence of the problems affecting the security and reliability of the water service transaction is reduced.

In some embodiments, the water service transaction system can further include: a simulation unit, and the simulation unit is configured to simulate a water supply capacity of the water service system. There can be multiple water service systems, for example, different regions and different manufacturers can have different water service systems, and different water service systems can have different water supply capacities. When performing the water service transaction, the actual water supply capacity of the water service system needs to meet the water supply requirement in the water service transaction, so that the transaction can be strictly performed, thereby ensuring the security and reliability of the transaction. For example, if a water scheduling contract requires to supply 5,000 tons of water per month, and a water service system has a monthly water supply volume of 10,000 tons, it is determined that the water service system can meet the requirement of the transaction, and the water service system can be scheduled for water supply. Meanwhile, when other water scheduling contracts need the water supply, the transaction corresponding to the other water scheduling contracts can be completed based on the remaining capacity of this water service system.

When determining the actual water supply capacity of a water service system, the field testing for water service system will consume a large amount of human and material resources. However, the information on water supply capacity provided directly by the manufacturer of the water service system may not be accurate, thereby affecting the security and reliability of the transaction. In embodiments of the present disclosure, the water service transaction system is provided with a simulation unit. The simulation unit can simulate the capacity of the water service system, thereby reducing the cost of determining the water service system.

In an embodiment, the simulation unit includes a virtual water meter and a virtual valve; the virtual water meter is configured to simulate a water meter entity of the water service system; the water meter entity is configured to display a water supply volume of the water service system; the virtual valve is configured to simulate the valve entity of the water service system; and the valve entity is configured to control the water supply of the water service system.

In the embodiment, the virtual water meter has the same attributes as the water meter entity of the simulated water service system, and the virtual valve has the same attributes as the valve entity of the simulated water service system. Therefore, through the virtual valve and water meter entity, the actual water supply condition in the water service system can be simulated. The water supply capacity of the virtual valve can be calculated through the diameter of the virtual valve and the reading of the virtual water meter, and the actual water supply capacity of the water service system can be simulated by calculating the water supply capacity of different virtual valves corresponding to the water service system. The above is only an example, the calculation method of the specific water supply capacity can be referred to the relevant art, which will not be repeated herein.

In the present disclosure, the user unit, the contract unit, and the scheduling unit can be realized simultaneously on the same electronic device, for example, by using an electronic device such as a supercomputer or a server. In some embodiments, any one or two of the user unit, the contract unit, and the scheduling unit can be realized on different electronic devices respectively, and the electronic devices where different units are located are communicatively connected. For example, the user unit is realized on different electronic devices respectively such as the cell phone and the computer, and the contract unit and scheduling unit can be realized on the server. Further, the server is communicatively connected to the electronic devices where all user units are located respectively, and the server is communicatively connected to the water service system. The foregoing is only an example, and should not be regarded as a limitation of the present disclosure.

Based on the same inventive concept, the embodiments of the present disclosure further provide a blockchain-based water service transaction method, applied to the blockchain-based water service transaction system provided by any one of the above embodiments. Next, the above blockchain-based water service transaction method will be described in conjunction with the above blockchain-based water service transaction system.

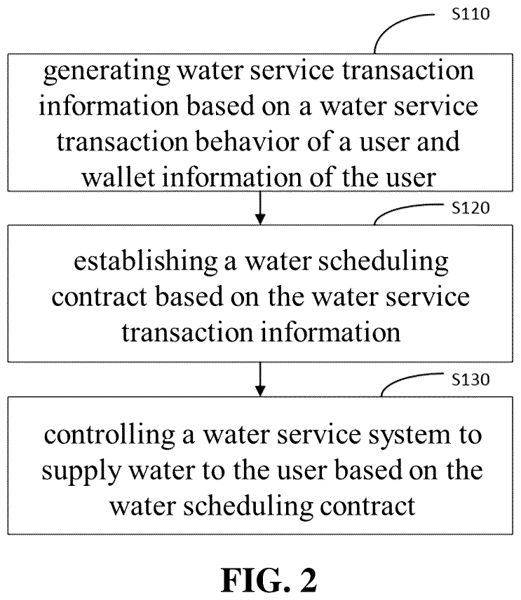

Referring to FIG. 2, FIG. 2 shows a flow diagram of a blockchain-based water service transaction method provided by the embodiments of the present disclosure. The blockchain-based water service transaction method can include the following steps: S110~S130.

S110: generating water service transaction information based on a water service transaction behavior of a user and wallet information of the user.

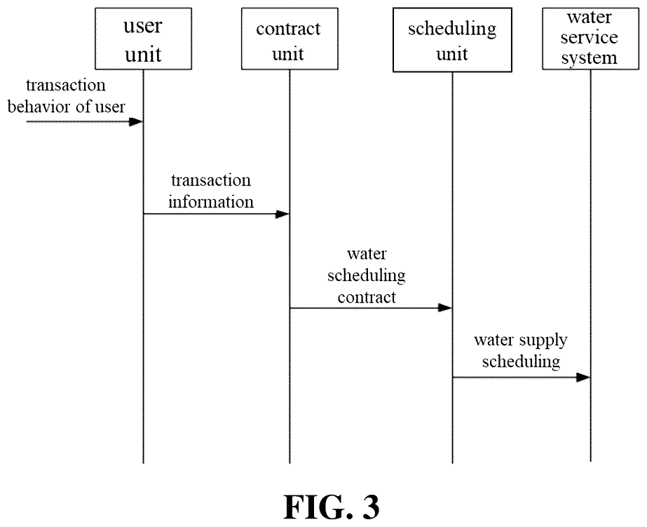

Referring to FIG. 3, FIG. 3 shows an interaction schematic diagram of a blockchain-based water service transaction system provided by the embodiments of the present disclosure.

In the embodiment, the user can perform the transaction behavior on the user unit. For example, the user can browse water-related information and perform the water service transaction on the visualized front-end interfaces, such as the program and web page on the cell phone or computer, and the user can perform fund management behavior on the user wallet module of the user unit, such as recharge and withdrawal.

The user wallet module can include the wallet information of the user. After the user performs the water service transaction behavior, such as purchase and cancellation on the user unit, the user unit will generate the water service transaction information based on the water service transaction behavior of the user and the wallet information of the user. The water service transaction information can include information such as the transaction time, the user, the transaction water volume, and the amount spent.

In the embodiments of the present disclosure, the wallet of the user is constructed by the blockchain. In an embodiment, before the step of generating water service transaction information based on a water service transaction behavior of a user and wallet information of the user, it can further construct a wallet of the user based on the blockchain, so as to manage the wallet information of the user based on an incentive mechanism of the blockchain. Through managing the wallet information of the user based on the incentive mechanism of the blockchain, it can improve the security of the wallet information of the user, which in turn ensures the safety of the fund of the user and improves the security of the transaction. For example, it takes the token in the blockchain incentive mechanism as the fund of the user, wherein the user can obtain token by recharge, and use the token to perform the transactions. The above is only an example, and the specific content of the blockchain incentive mechanism can be referred to the relevant art, which will not be repeated herein.

S120: establishing a water scheduling contract based on the water service transaction information.

In the embodiment, after generating the water service transaction information, the user unit can send the water service transaction information to the contract unit, and the contract unit can establish a water scheduling contract based on the water service transaction information.

The water scheduling contract can be a smart contract generated based on the blockchain. Through the smart contract, the water scheduling contract can be more secure to avoid tampering, so that the security of the water service transaction can be improved, and the transaction can be made to be strictly performed according to the water scheduling contract, thereby improving the reliability of the water service transaction.

S130: controlling a water service system to supply water to the user based on the water scheduling contract.

In the embodiment, after the water scheduling contract is established by the contract unit, the water scheduling contract can be sent to the scheduling unit. The scheduling unit is communicatively connected to the water service system, and the scheduling unit can schedule the water supply of the water service system according to the contents of the water scheduling contract.

Before the step of controlling the water service system to supply water to the user based on the water scheduling contract by the scheduling unit, it can further review a validity of the water scheduling contract based on the water service transaction information, wherein it is to refuse to perform the water scheduling contract whose validity dose not satisfy the preset requirement, or to perform the valid water scheduling contract.

It can be understood that the above blockchain-based water service transaction method corresponds to the functions of the blockchain-based water service transaction system, and the specific implementation can be referred to the above blockchain-based water service transaction system, which will not be repeated herein.

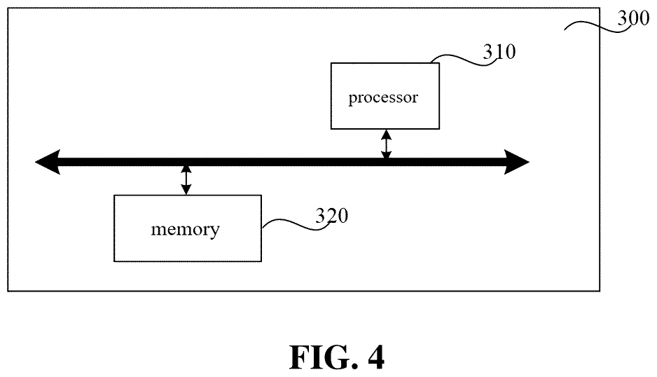

The above blockchain-based water service transaction method can be realized in the form of a computer-readable instruction, and the computer-readable instruction can be performed on the electronic device as shown in FIG. 4.

Referring to FIG. 4, the embodiments of the present disclosure further provide an electronic device 300, which can serve as an execution body of the foregoing blockchain-based water service transaction method. When the user unit, the contract unit, and the scheduling unit are realized on the same electronic device, the electronic device 300 can realize the functions of the foregoing blockchain-based water service transaction system.

The electronic device 300 can include: a processor 310 and a memory 320 communicatively connected to the processor 310.

The memory 320 stores instructions executable by the processor 310, and the instructions are executed by the processor 310, so that the processor 310 can execute the blockchain-based water service transaction method in the foregoing embodiments or realize the functions of the blockchain-based water service transaction system in the foregoing embodiments.

The processor 310 and the memory 320 can be connected via a communication bus, or via some communication modules, such as wireless communication module, Bluetooth communication module, and 4G/5G communication module. In some embodiments, the communication module can further be configured to communicatively connect to the water service system.

The processor 310 can be an integrated circuit chip having a signal processing capability. The processor 310 can be a general-purpose processor, including a CPU (central processing unit), NP (network processor), etc. It can also be a digital signal processor, application specific integrated circuit, and field programmable gate array, or other programmable logic component, discrete gate or transistor logic component, and discrete hardware component, which can be used to realize or execute the methods, steps, and logic block diagrams disclosed in embodiments of the present disclosure, wherein the general-purpose processor can be a microprocessor, or the processor can be any conventional processor, etc.

The memory 320 can include, but is not limited to RAM (random access memory), ROM (read-only memory), PROM (programmable read-only memory), EPROM (erasable programmable read-only memory), and EEPROM (electric erasable programmable read-only memory), etc.

It can be understood that the electronic device 300 can further include more general modules required by itself, which will not be described in detail in the embodiments of the present disclosure.

The embodiments of the present disclosure further provide a computer-readable medium, wherein the computer-readable storage medium stores a computer program, and when the computer program is executed by the computer, the blockchain-based water service transaction method in the foregoing embodiments is executed or the functions of the blockchain-based water service transaction system in the foregoing embodiments are realized.

In the embodiments provided by the present disclosure, it should be understood that the disclosed system and method can also be realized in other ways. The embodiments of the system described above are only illustrative, for example, the division of the units is only a logical functional division, and it can be divided in another way when actually realized. Alternatively, for example, multiple units or components can be combined or can be integrated into another system, or some features can be ignored, or not be executed. Additionally, the mutual coupling or direct coupling or communication connection shown or discussed can be an indirect coupling or communication connection via some communication interfaces or units, which can be electrical, mechanical, or other forms.

Further, the unit illustrated as a separated component can or cannot be physically separated, and the components shown as a unit can or cannot be a physical unit. That is, it can be located on a single place, or it can be distributed on a plurality of network units. Some or all of these units can be selected to fulfill the objective of the solution of the embodiment according to actual needs.

Moreover, the various functional modules in various embodiments of the present disclosure can be integrated together to form a separate part, individual modules can exist alone, or two or more modules that can be integrated to form a separate part.

The foregoing are merely embodiments of the present disclosure, and are not used to limit the scope of the protection of the present disclosure. For those skilled in the art, the present disclosure may have various changes and variations. Any modifications, equivalent replacements, improvements, etc., made within the spirit and principles of the present disclosure, shall be included within the scope of protection of the present disclosure.

### INDUSTRIAL APPLICABILITY

The present disclosure provides a blockchain-based water service transaction method, a blockchain-based water service transaction system, an electronic device, and a storage medium, which relate to the field of water service transactions. The blockchain-based water service transaction system includes: a user unit, wherein the user unit includes a user wallet module and a user transaction module; the user transaction module is configured to generate water service transaction information based on a water service transaction behavior of a user and the user wallet module; the user wallet module is configured to manage wallet information of the user; and the user wallet module is a wallet module constructed by the blockchain; a contract unit, wherein the contract unit is configured to establish a water scheduling contract based on the water service transaction information; a scheduling unit, wherein the scheduling unit is communicatively connected to a water service system, and the scheduling unit is configured to control the water service system to supply water to the user based on the water scheduling contract. The security and reliability of water service transactions can be improved by the above blockchain-based water service transaction system.

Furthermore, it will be appreciated that the blockchain-based water service transaction system of the present disclosure is reproducible and can be applied to various industrial applications. For example, the blockchain-based water service transaction system of the present disclosure can be applied in a water service system that requires water to supply water to the user.

1. A blockchain-based water service transaction system, wherein the blockchain-based water service transaction system comprises:
a user unit, wherein the user unit comprises a user wallet module and a user transaction module; the user transaction module is configured to generate water service transaction information based on a water service transaction behavior of a user and the user wallet module; the user wallet module is configured to manage wallet information of the user; and the user wallet module is a wallet module constructed by the blockchain;
a contract unit, wherein the contract unit is configured to establish a water scheduling contract based on the water service transaction information; and
a scheduling unit, wherein the scheduling unit is communicatively connected to a water service system, and the scheduling unit is configured to control the water service system to supply water to the user based on the water scheduling contract.

2. The blockchain-based water service transaction system according to claim 1, wherein the user wallet module manages wallet information of the user based on an incentive mechanism of the blockchain.

3. The blockchain-based water service transaction system according to claim 1, wherein the user unit further comprises a user information module, and the user information module is configured to record multiple types of information of the user.

4. The blockchain-based water service transaction system according to claims 1, wherein the user unit further comprises a user management module, and the user management module is configured to manage own affairs of the user.

5. The blockchain-based water service transaction system according to claim 1, wherein the contract unit comprises a blockchain module and a contract module; the blockchain module is configured to enable the contract unit to perform basic functions of the blockchain; and the contract module is configured to generate a smart contract corresponding to the water scheduling contract based on the water service transaction information and the functions of the blockchain module.

6. The blockchain-based water service transaction system according to claim 1, wherein the scheduling unit comprises a contract review module, and the contract review module is configured to review a validity of the water scheduling contract based on the water service transaction information and to refuse to execute a water scheduling contract whose validity does not satisfy a preset requirement.

7. The blockchain-based water service transaction system according to claim 1, wherein the scheduling unit comprises:
a virtual water meter object buffer pool, wherein the virtual water meter object buffer pool comprises a plurality of virtual water meter objects, and each of the virtual water meter objects is synchronized with information of different water meters in the water service system respectively; and
a virtual water valve control module, wherein the virtual water valve control module is communicatively connected to a water supply valve of the water service system, and the virtual water valve control module is configured to control opening and closing of the water supply valve based on the water scheduling contract and the virtual water meter, so that the water service system supplies water to the user.

8. The blockchain-based water service transaction system according to claim 6, wherein the scheduling unit further comprises a buffer queue module; the buffer queue module is configured to cache a plurality of water scheduling contracts, and to control the plurality of water scheduling contracts to enter the contract review module in sequence; and the scheduling center executes the reviewed smart contract in sequence.

9. The blockchain-based water service transaction system according to claim 1, wherein the blockchain-based water service transaction system further comprises: a simulation unit, and the simulation unit is configured to simulate a water supply capacity of the water service system;
the simulation unit comprises a virtual water meter and a virtual valve; the virtual water meter is configured to simulate a water meter entity of the water service system; the water meter entity is configured to display a water supply volume of the water service system; and
the virtual valve is configured to simulate a valve entity of the water service system; and the valve entity is configured to control the water supply of the water service system.

10. A blockchain-based water service transaction method, wherein the blockchain-based water service transaction method comprises:
generating water service transaction information based on a water service transaction behavior of a user and wallet information of the user, wherein the wallet is a blockchain wallet;
establishing a water scheduling contract based on the water service transaction information; and
controlling a water service system to supply water to the user based on the water scheduling contract.

11. The blockchain-based water service transaction method according to claim 10, wherein before a step of generating water service transaction information based on a water service transaction behavior of a user and wallet information of the user, the blockchain-based water service transaction method further comprises:
constructing a wallet of the user based on the blockchain, so as to manage the wallet information of the user based on an incentive mechanism of the blockchain.

12. The blockchain-based water service transaction method according to claim 11, wherein before a step of controlling a water service system to supply water to the user based on the water scheduling contract, the blockchain-based water service transaction method further comprises:
reviewing a validity of the water scheduling contract based on the water service transaction information, and
refusing to execute a water scheduling contract whose validity does not satisfy a preset requirement.

13. An electronic device, wherein the electronic device comprises a memory and a processor; the memory stores a computer-readable instruction; and when the computer-readable instruction is performed by the processor, the processor executes the blockchain-based water service transaction method according to claim 10.

14. A computer-readable storage medium, wherein the computer readable storage medium stores a computer program, and when the computer program is performed on a computer, the computer executes the blockchain-based water service transaction method according to claim 10.

15. An electronic device, wherein the electronic device comprises a memory and a processor; the memory stores a computer-readable instruction; and when the computer-readable instruction is performed by the processor, the processor implements functions of the blockchain-based water service transaction system according to claim 1.

16. A computer-readable storage medium, wherein the computer readable storage medium stores a computer program, and when the computer program is performed on a computer, the computer implements functions of the blockchain-based water service transaction system according to claim 1.
